(19) United States
(12) Patent Application Publication
(10) Pub. No.: US 2016/0012710 A1
(43) Pub. Date: Jan. 14, 2016

(54) SMART MEDICATION DEVICE

(71) Applicant: SiPix Technology Inc., Taoyuan City (TW)

(72) Inventors: Yen-Hsing Lu, Taoyuan City (TW); Chi-Mao Hung, Taoyuan City (TW); Chung-Hui Lee, Taoyuan City (TW)

(21) Appl. No.: 14/794,833

(22) Filed: Jul. 9, 2015

Related U.S. Application Data
(60) Provisional application No. 62/022,671, filed on Jul. 10, 2014.

(51) Int. Cl. G08B 21/24

(52) U.S. Cl. CPC G08B 21/24

(57) ABSTRACT

A smart medication device including a non-electrical component and an electrical component is provided. The non-electrical component includes a containing structure configured to contain one or more medicines. The electrical component is disposed on the non-electrical component. The electrical component includes a triggering structure and an e-paper display apparatus. The triggering structure is configured to generate a triggering signal to trigger the e-paper display apparatus to display medicine administration information. The triggering structure is deformed by receiving an external force to generate the triggering signal. An electrical characteristic of the triggering signal is determined by a structure characteristic of the triggering structure.

### CROSS-REFERENCE TO RELATED APPLICATION

This application claims the priority benefits of U.S. provisional application Ser. No. 62/022,671, filed on Jul. 10, 2014. The entirety of each of the above-mentioned patent applications is hereby incorporated by reference herein and made a part of this specification.

### BACKGROUND OF THE INVENTION

1. Field of the Invention

The invention relates to a smart medication device, and particularly relates to a smart medication device having a triggering structure.

2. Description of Related Art

In the era of rapid changes in technology, modern people often forget to take medicines according to doctor's prescriptions due to busy work. On the other hand, the modern society has gradually entered an aging society, and elderly care is also a very important issue. Due to memory decline, the elderly cannot follow doctor's prescriptions to take medicines. Although there are a variety of devices and mechanisms to remind a patient to take medicines, the biggest problem is that the patient forgot whether he/she hasn't taken the medicines. Therefore, in all the time, it has caused a waste of a large amount of resources in the pharmaceutical field as patients conditions are deteriorated or cannot be controlled due to that the patients do not follow the doctor's prescriptions to cause insufficient dosage or repeated doses, which further results in a high social cost. Therefore, how to effectively improve patient compliance/adherence has become an important topic in the pharmaceutical field.

In the existing technique, a liquid crystal display (LCD) device can be used in collaboration with a medicine bottle to serve as a smart medication device for displaying medicine administration information. However, such smart medication device generally has a complicated circuit design, and has a high power consumption, which probably increases a volume, thickness or manufacturing cost of the smart medication device, and the smart medication device cannot be reused. Moreover, in a specific application environment, the smart medication device equipped with the LCD device probably has a problem of insufficient contrast, and cannot provide good display quality.

### SUMMARY OF THE INVENTION

The invention is directed to a smart medication device, which displays a medicine administration information to remind a user to take medicine according to a triggering signal, and provides good display quality.

The invention provides a smart medication device including a non-electrical component and an electrical component. The non-electrical component includes a containing structure. The containing structure is configured to contain one to a plurality of medicines. The electrical component is disposed on the non-electrical component. The electrical component includes a triggering structure and an e-paper display apparatus. The triggering structure is configured to generate a triggering signal to trigger the e-paper display apparatus to display medicine administration information. The triggering structure is deformed by receiving an external force to generate the triggering signal. The triggering signal has an electrical characteristic, and the electrical characteristic is determined by a structure characteristic of the triggering structure.

In an embodiment of the invention, the containing structure includes a carrying substrate and a plurality of containing grooves. The carrying substrate is configured to carry the electrical component. The containing grooves are disposed on the carrying substrate, and are respectively configured to contain one to a plurality of medicines.

In an embodiment of the invention, the non-electrical component further includes a box housing, and the containing structure is disposed in the box housing.

In an embodiment of the invention, the e-paper display apparatus is disposed on one of the carrying substrate and the box housing.

In an embodiment of the invention, the triggering structure is disposed on the box housing. When the box housing is changed from a first use state to a second use state, the triggering structure is deformed by receiving the external force to generate the triggering signal.

In an embodiment of the invention, the triggering structure is disposed on the containing grooves. When each of the containing grooves is deformed by receiving the external force, the triggering structure is deformed by receiving the external force to generate the triggering signal.

In an embodiment of the invention, each of the containing grooves includes a top portion and an opening portion. The triggering structure is disposed on one of the top portion and the opening portion.

In an embodiment of the invention, the electrical component further includes a controller and a power storage device. The controller is disposed on the containing structure, and is configured to receive the triggering signal. The power storage device is electrically connected to the controller, and is configured to provide power required by the controller.

In an embodiment of the invention, the triggering structure includes a piezoelectric material element. The structure characteristic of the triggering structure includes at least one of a shape, a length, a width and an area of the piezoelectric material element.

In an embodiment of the invention, the triggering structure includes a conductive material element. The structure characteristic of the triggering structure includes at least one of a shape, a length, a width and an area of the conductive material element.

In an embodiment of the invention, the electrical characteristic of the triggering signal includes at least one of a current value and a voltage value of the triggering signal.

According to the above descriptions, in the embodiment of the invention, by exerting the external force to the triggering structure on the smart medication device, the triggering structure is deformed by receiving the external force, and the triggering signal is generated according to the corresponding structure characteristic of the triggering structure. The e-paper display apparatus displays the medicine administration information according to the triggering signal to further remind the user to take medicine, so as to effectively decrease a waste of medical resources.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1C are schematic diagrams of a smart medication device in different states according to an embodiment of the invention.

FIG. 1D to FIG. 1F are schematic diagrams illustrating applications of the smart medication device of FIG. 1A to FIG. 1C.

FIG. 1G is a schematic diagram illustrating a circuit component configuration according to an embodiment of the invention.

FIG. 2A is a schematic diagram of a smart medication device according to another embodiment of the invention.

FIG. 2B to FIG. 2C are schematic diagrams illustrating applications of the smart medication device of FIG. 2A.

FIG. 3A is a schematic diagram of a smart medication device according to another embodiment of the invention.

FIG. 3B is a schematic diagram illustrating a circuit component configuration according to another embodiment of the invention.

FIG. 4 is a schematic diagram of a smart medication device according to another embodiment of the invention.

### DESCRIPTION OF EMBODIMENTS

A plurality of embodiments is provided below to describe the invention, though the invention is not limited to the provided embodiments, and the embodiments can also be suitably combined. A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, a term “signal” refers to at least a current, a voltage, an electric charge, a temperature, data or any other one or a plurality of signals.

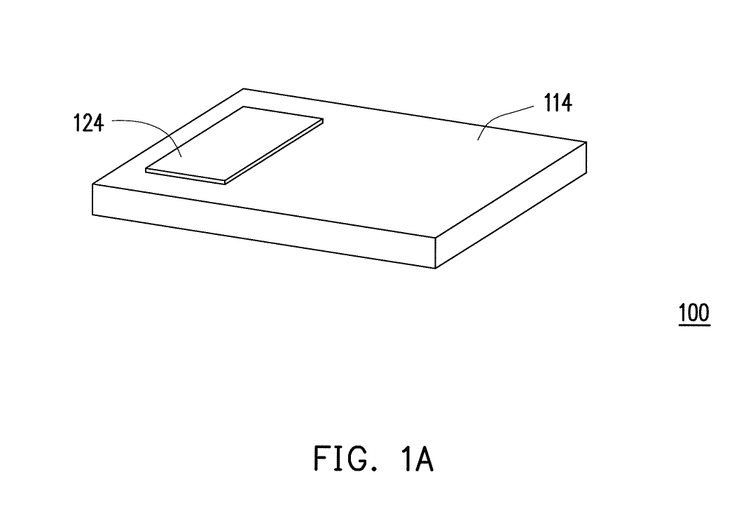

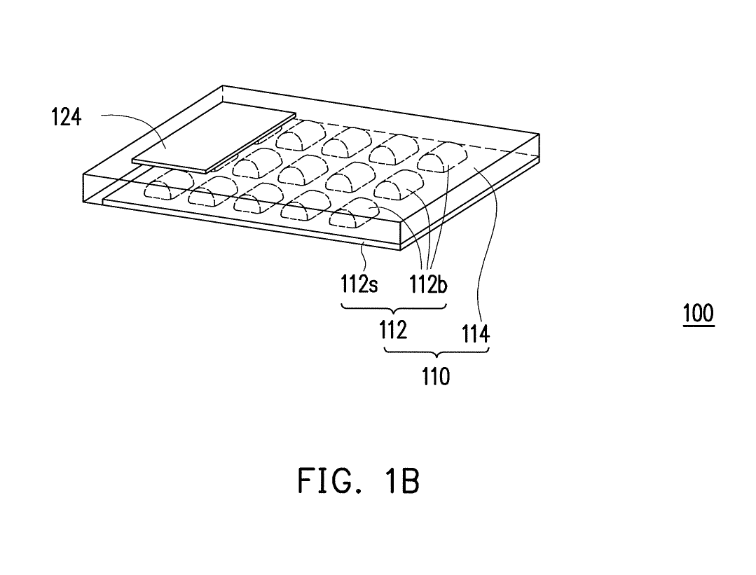

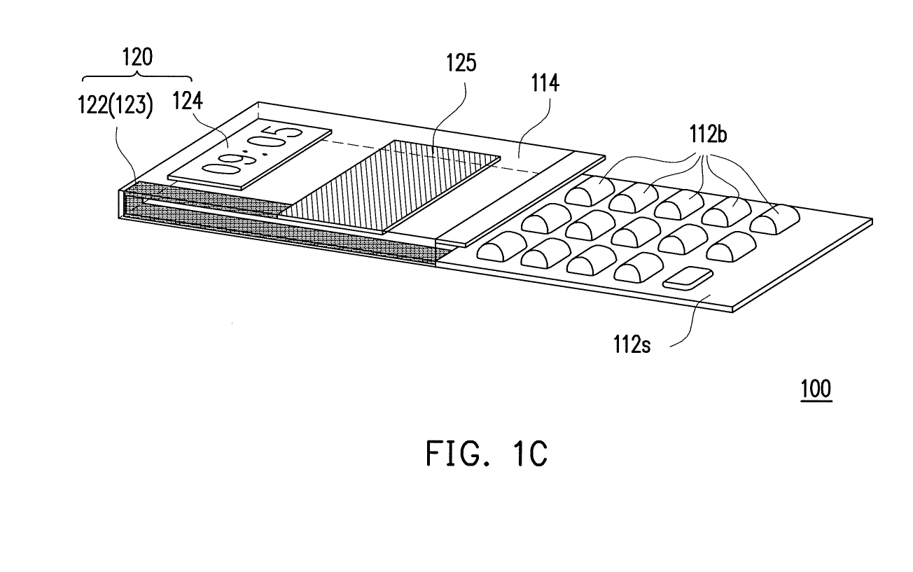

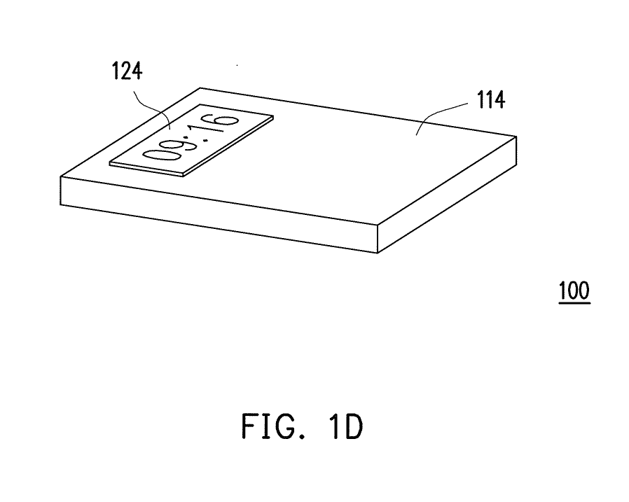

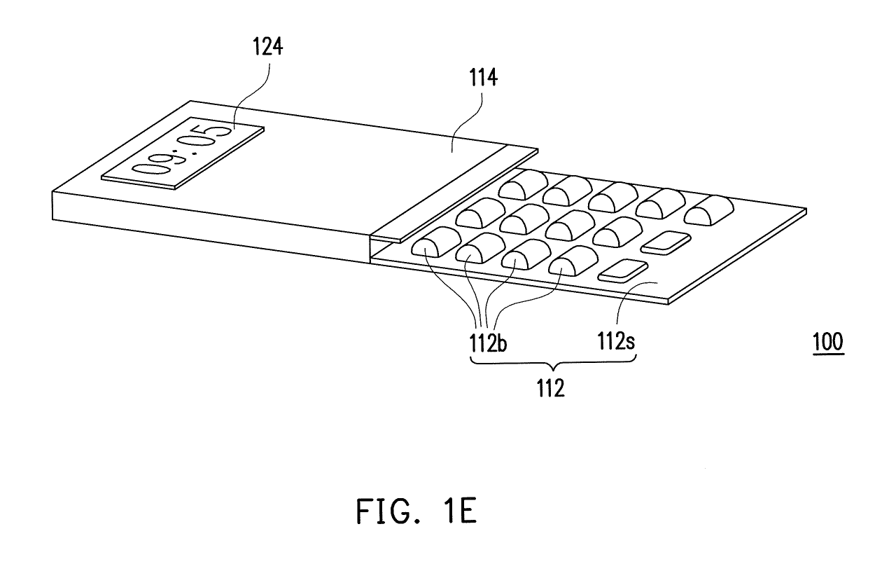

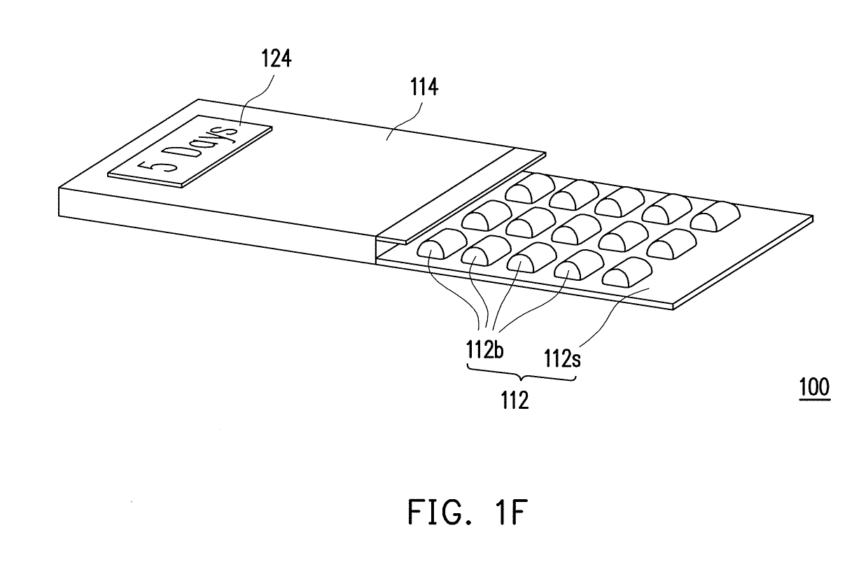

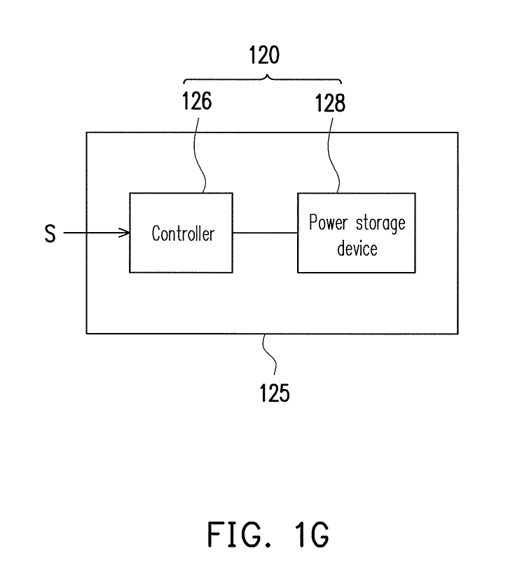

FIG. 1A to FIG. 1C are schematic diagrams of a smart medication device in different states according to an embodiment of the invention. FIG. 1A is a schematic diagram of the smart medication device in a close state according to an embodiment of the invention. FIG. 1B is a perspective view of the smart medication device in the close state according to an embodiment of the invention. FIG. 1C is a schematic diagram of the smart medication device in an open state according to an embodiment of the invention. FIG. 1D to FIG. 1F are schematic diagrams illustrating applications of the smart medication device of FIG. 1A to FIG. 1C. FIG. 1G is a schematic diagram illustrating a circuit component configuration according to an embodiment of the invention.

Referring to FIG. 1A to FIG. 1C, in the present embodiment, the smart medication device 100 includes a non-electrical component 110 and an electrical component 120. The electrical component 120 is disposed on the non-electrical component 110. The electrical component 120 includes a triggering structure 122 and an e-paper display apparatus 124. The triggering structure 122 is deformed by receiving an external force to generate a triggering signal S. The triggering signal S is configured to trigger the e-paper display apparatus 124 to display medicine administration information. An electrical characteristic of the triggering signal S is, for example, determined by a structure characteristic of the triggering structure 122. In the present embodiment, the electrical characteristic of the triggering signal S, for example, includes at least one of a current value and a voltage value thereof, and the structure characteristic of the triggering structure 122, for example, includes but not limited to at least one of a shape, a length, a width and an area thereof.

In the present embodiment, the non-electrical component 110 includes a containing structure 112 and a box housing 114. The box housing 114 is, for example, a medicine box. The containing structure 112 is disposed in the box housing 114 for containing one or a plurality of medicines. The containing structure 112 includes a carrying substrate 112s and a plurality of containing grooves 112b. The containing grooves 112b are disposed on the carrying substrate 112s, and are respectively configured to contain one or a plurality of medicines. Moreover, in the present embodiment, the e-paper display apparatus 124 is, for example, disposed on the box housing 114, though the invention is not limited thereto. In another embodiment, the e-paper display apparatus 124 can also be disposed on the carrying substrate 112s. In the present embodiment, the triggering structure is deformed by receiving the external force when a use state of the box housing 114 is changed, so as to generate the triggering signal S.

To be specific, the triggering structure 122 of the present embodiment includes a piezoelectric material element 123. Therefore, when the box housing 114 is changed from a first use state to a second use state, the piezoelectric material element 123 is deformed due to the external force to generate the triggering signal S, and the triggering signal S is output to a controller 126 of FIG. 1G. The first use state is, for example, a close state of the box housing 114 (shown in FIG. 1A and FIG. 1B) when the user does not open the box housing 114 to take medicine, and the second use state is, for example, an open state of the box housing 114 (shown in FIG. 1C) when the user opens the box housing 114 to take medicine. During the opening process, the triggering structure 122 is deformed by receiving the external force to generate the triggering signal S. It should be noted that the invention is not limited to the aforementioned first use state or the second use state.

Since the triggering structure 122 of the present embodiment includes the piezoelectric material element 123, the structure characteristic of the triggering structure 122 includes at least one of a shape, a length, a width and an area of the piezoelectric material element 123. Therefore, the piezoelectric material element 123 is deformed under the external force to convert mechanical energy into electrical energy. The trigger signal S generated by the piezoelectric material element 123 is used for triggering the e-paper display apparatus 124 to display the medicine administration information. A voltage value or a current value of the triggering signal S is different when the shape, the length, the width and the area of the piezoelectric material element 123 is different.

In the present embodiment, a material of the piezoelectric material element 123 includes Lead zirconium titanate (PZT), barium titanate, polyvinylidene fluoride (PVDF), lead magnesium niobate (PMN-PT), bismuth titanate, LiNbO₃ or KNbO₃, or a combination of the above materials, which is not limited by the invention.

Moreover, a mode that the triggering structure 122 is deformed due to the external force include a bending mode, a stretching mode, a twisting mode, a push mode, a sliding mode or an agitating mode, such that the trigger structure 122 is deformed in different patterns, though the invention is not limited thereto.

On the other hand, in the present embodiment, the electrical component 120 further includes the controller 126 and a power storage device 128. The controller 126 and the power storage device 128 are, for example, disposed on a circuit substrate 125. In the present embodiment, the circuit substrate 125 is, for example, a printed circuit board (PCB). The controller 126 is configured to receive the triggering signal S to control the e-paper display apparatus 124 to display the medicine administration information. The power storage device 128 is electrically connected to the controller 126, and is configured to provide power required by the controller 126. In the present embodiment, the power storage device 128, for example, includes a power battery, a solar battery, a super capacitor, a rechargeable battery or a wireless rechargeable battery, which is not limited by the invention. In the present embodiment, the circuit substrate 125 is, for example, disposed in the box housing 114, though the invention is not limited thereto. In other embodiments, the circuit substrate 125 can be disposed outside the box housing 114, or is disposed on the carrying substrate 112s. In other words, configuration positions of the circuit substrate 125, the controller 126 and the power storage device 128 are not limited by the invention. Moreover, if electric energy of the triggering signal S of the triggering structure 122 is great enough, the power storage device 128 can be omitted.

In the present embodiment, the medicine administration information displayed by the e-paper display apparatus 124, for example, includes a medicine-taking time of the user. Therefore, in an embodiment, the electrical component 120 may further include a real time clock (RTC, not shown). To be specific, when the triggering structure 122 is deformed by receiving the external force to generate the triggering signal S, the RTC generates a time/date corresponding to a medicine-taking moment of the user and time information related to date according to the triggering time S. The controller 126 controls the e-paper display apparatus 124 to display the medicine administration information according to the time information.

In the present embodiment, the controller 126 is, for example, a micro-controller unit (MCU), a central processing unit (CPU), or other microprocessor, a digital signal processor (DSP), a programmable controller, application specific integrated circuits (ASIC), a programmable logic device (PLD), or other similar devices.

It should be noted that a display technique used by the e-paper display apparatus 124 of the present embodiment is a display technique having a bi-stable characteristic. Therefore, after the medicine administration information is displayed, before a next display of a new medicine administration information, it is unnecessary to keep providing extra power. Namely, the e-paper display apparatus 124 of the present embodiment can maintain the medicine administration information for a long time, and it is required to again provide power only when the medicine administration information is updated for the next time, so as to achieve a power-saving function. In the present embodiment, the e-paper display apparatus 124 includes an electrophoretic display, an electrokinetic display, an electrochromic display, an electrofluidic display, a liquid powder display, a cholesteric liquid-crystal display, an electromechanical interference modulation display or a reflective liquid-crystal display, which is not limited by the invention.

In the present embodiment, the medicine administration information is, for example, a time when the user opens the box housing 114 to take medicine. For example, referring to FIG. 1D and FIG. 1E, according to FIG. 1D, it is known that the smart medication device 100 is in the first use state, which indicates a previous time when the user took medicine, for example, Tuesday morning 9:16. Then, according to FIG. 1E, it is known that the smart medication device 100 is in the second use state, which represents that the user now opens the box housing 114, and the medicine administration information of the e-paper display apparatus 124 is correspondingly updated to show a second time when the user took medicine at Wednesday morning 9:05, so as to record a new medicine administration information.

Referring to FIG. 1F, in the present embodiment, the medicine administration information may also include medicine saving information. In detail, when the user opens the box housing 114 to take medicine, the controller 126 compares the time information recorded by itself or the time information provided by the RTC with an expiration date of the medicine to learn whether the medicine has expired. If the medicine is in an expiration state, the controller 126 controls the e-paper display apparatus 125 to display saving information reminding the user that the medicine has expired. As shown in FIG. 1F, the medicine administration information displayed by the e-paper display apparatus 124 is that the medicine has expired for 5 days. Therefore, the smart medication device 100 of the present embodiment can remind the user to not use the expired medicines.

Therefore, in the present embodiment, the e-paper display apparatus 124 of the smart medication device 100 can display the medicine-taking time of the user, and the user can confirm by himself whether he has followed doctors' prescriptions to take medicines, so as to improve a chance of correct medicine-taking. Moreover, the smart medication device 100 of the present embodiment can remind the user to not use the expired medicines.

It should be noted that a part of contents of the aforementioned embodiments are also used in the following embodiments, and descriptions of the same technical contents are omitted. The aforementioned embodiments can be referred for descriptions of the omitted parts, and detailed descriptions thereof are not repeated in the following embodiments.

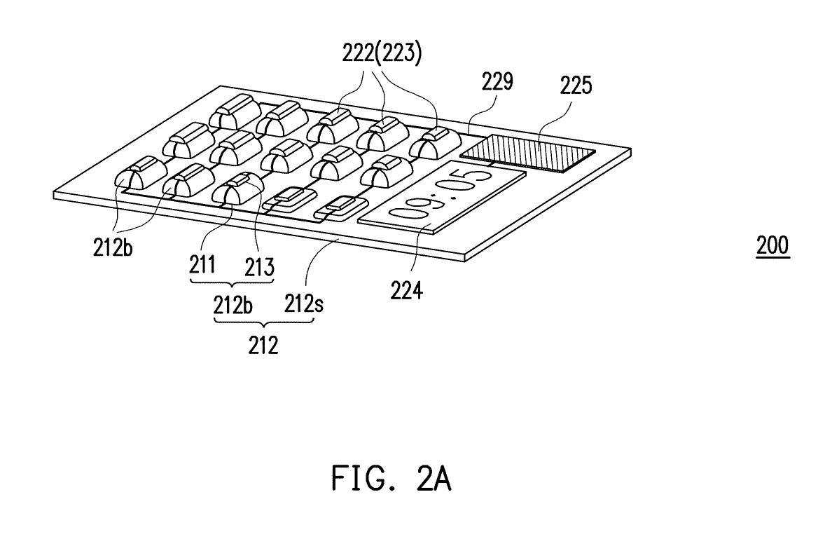

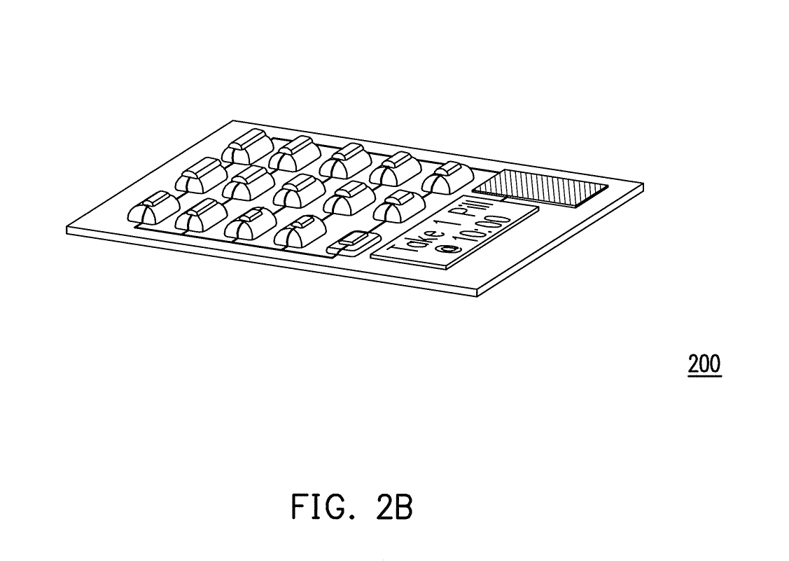

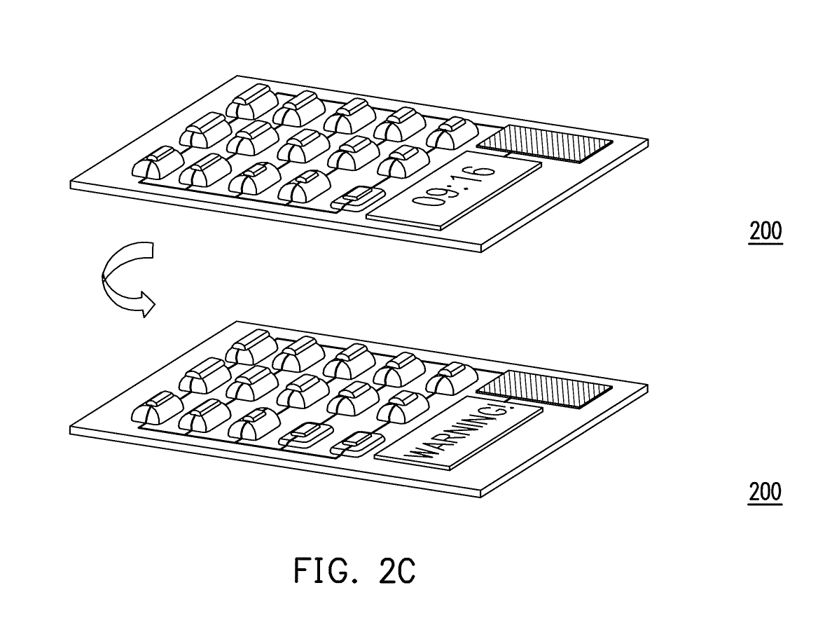

FIG. 2A is a schematic diagram of a smart medication device according to another embodiment of the invention. FIG. 2B to FIG. 2C are schematic diagrams illustrating applications of the smart medication device of FIG. 2A.

Referring to FIG. 2A, in the present embodiment, the smart medication device 200 is similar to the smart medication device 100 of the embodiment of FIG. 1A to FIG. 1C, and a main difference therebetween is that the triggering structure 222 of the present embodiment is disposed on a top portion 213 of each of the containing grooves 212b, and the e-paper display apparatus 224 and the circuit substrate 225 of the present embodiment are disposed on the carrying substrate 212s. The circuit substrate 225, for example, includes the controller 126 and the power storage device 128 shown in FIG. 1G, which is not limited by the invention.

To be specific, in the present embodiment, the containing groove 212b includes the top portion 213 and an opening portion 211. The triggering structures 222 are, for example, disposed on the top portions 213 of the containing grooves 212b, though the invention is not limited thereto. In another embodiment, the triggering structures can also be disposed on the opening portions of the containing grooves, which are not limited by the invention. In the present embodiment, when the containing groove 212b is deformed by receiving the external force, the triggering structure 222 is also deformed by receiving the external force to generate the triggering signal S. For example, in FIG. 2A, the two containing grooves 212b close to the e-paper display device 224 has been deformed, and while the containing grooves 212b are deformed, the containing grooves 212b respectively generate the triggering signal S, and transmit the triggering signals S to the controller 126 on the circuit substrate 225 through a conducting wire 229. Moreover, the smart medication device 200 of the present embodiment may also be disposed in a box housing, which is not limited by the invention.

In the present embodiment, the triggering structures 222, for example, respectively include piezoelectric material elements 223 with different structure characteristics. For example, in the present embodiment, the piezoelectric material elements 223 are different in one of the structure characteristics of length, width and area.

It should be noted that in the present embodiment, the shape of the piezoelectric material element 223 is, for example, a rectangle, though the invention is not limited thereto. In other embodiments, the shape of the triggering structure 222 can also be a round, a triangle, a square or other polygons, which is not limited by the invention.

To be specific, when the user takes the medicine from each of the containing grooves 212b, the user exerts an external force to the top portion 213 of the containing groove 212b, such that the triggering structure 222 is deformed by receiving the external force to generate the triggering signal. Since the triggering structures 222 have different structure characteristics, when the user takes the medicines in the containing grooves 212b of different positions, the corresponding triggering structures 222 may produce the triggering signal S with different voltage values or current values. The controller 126 of the smart medication device 200 can obtain the positions of the containing grooves 212b according to a look-up table. The look-up table of the present embodiment, for example, records a relationship between the voltage values or the current values of the triggering signal S and different positions of the containing grooves 212b. Therefore, the smart medication device 200 can learn the position of the medicine taken by the user. For example, in FIG. 2A, regarding the piezoelectric material element 223 of the triggering structure 222 with a larger area, a longer length or a wider width, the voltage value or the current value of the triggering signal S thereof produced during the deformation is probably greater. Therefore, besides that the smart medication device 200 can display the medicine-taking time of the user, the smart medication device 200 can also record the positions of the medicines taken by the user.

On the other hand, referring to FIG. 2B, the controller 126 of the present embodiment controls the e-paper display apparatus 224 to display dynamic information for reminding the user with the medicine-taking time. In detail, the controller 126 can control the e-paper display apparatus 224 to display the medicine administration information to remind the user to take medicine at a fixed time every day, and can further cultivate the user's habit for taking medicine at fixed time. As shown in FIG. 2B, the medicine administration information displayed by the e-paper display apparatus 224 is to remind the user to take medicine at 10 o'clock in the morning.

Then, referring to FIG. 2C, the medicine administration information of the present embodiment may also include reminding the user not to overuse the medicine. For example, if a medical staff instructs the user to take one pill each day, as shown in FIG. 2C, when the user presses two containing grooves 212b to deform the containing grooves 212b in a same day, the controller 126 can compare the time information recorded by itself or the time information provided by the RTC with the instruction of the medical staff to learn that the user overuses the medicines. Then, the controller 126 controls the e-paper display apparatus 224 to display specific medicine administration information (for example, a warning message) to warn the user not to overuse the medicine.

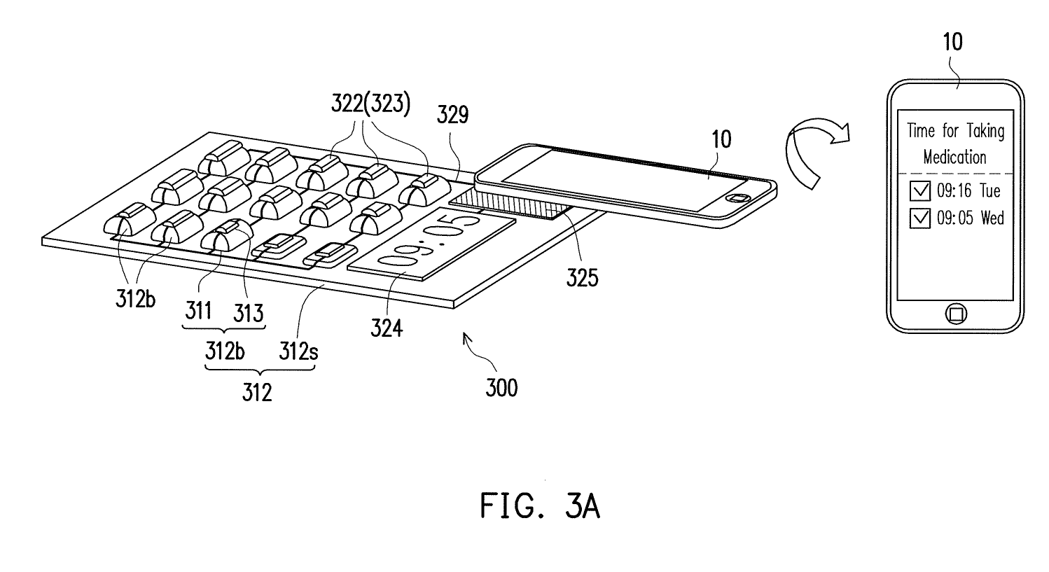

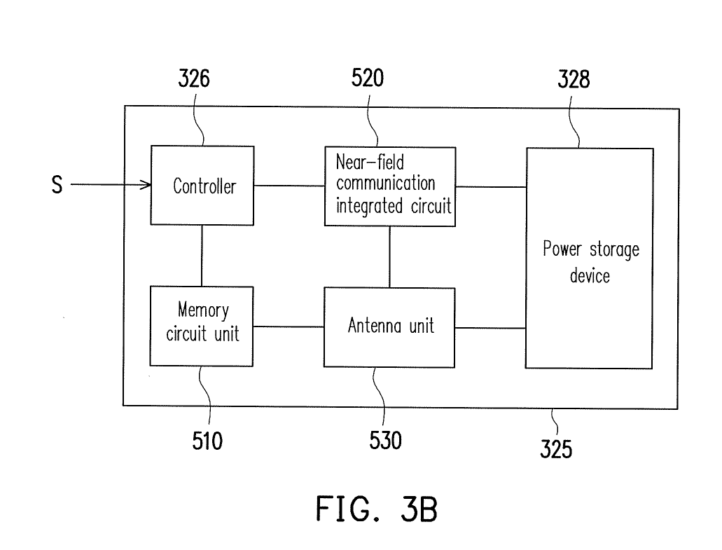

FIG. 3A is a schematic diagram of a smart medication device according to another embodiment of the invention. FIG. 3B is a schematic diagram illustrating a circuit component configuration according to another embodiment of the invention. Referring to FIG. 3A and FIG. 3B, a difference between the smart medication device 300 of the present embodiment and the smart medication device 200 of the embodiment of FIG. 2A is that the smart medication device 300 of the present embodiment can implement wireless communication with an electronic apparatus 10 to exchange the medicine administration information.

In the present embodiment, a memory circuit unit 510, a near-field communication integrated circuit 520 and an antenna unit 530 can be further configured on the circuit substrate 325. The memory circuit unit 510 is configured to store the medicine administration information. The electronic apparatus 10 reads the medicine administration information stored in the memory circuit unit 510 through the near-field communication integrated circuit 520 and the antenna unit 530, or the medicine administration information can be written into the memory circuit unit 510 through the electronic apparatus 10. In the present embodiment, the electronic apparatus 10 is, for example, a smart handheld mobile device, though the invention is not limited thereto.

Therefore, the smart medication device 300 of the present embodiment can store the medicine administration information of the user, and the medical staff can read the medicine administration information of the user through the electronic apparatus 10, so as to learn whether the user follows the prescriptions to take the medicines. If the user follows the prescriptions to take the medicines, the user can get a corresponding reward. For example, the reward is a discount in buying the medicines, so as to provide the user with the motivation to take medicine on time. On the other hand, if the user does not follow the prescriptions to take the medicines, the medical staff can further tracks whether the user follows the prescriptions to take the medicines according to the medicine administration information, so as to effectively remind the user to take medicine on time.

In the present embodiment, the medical staff can also write written information stored in the electronic apparatus 10 into the memory through the near-field communication integrated circuit 520 and the antenna unit 530. For example, the written information can be a latest medicine-taking instruction from the medical staff. In other words, the smart medication device 300 of the present embodiment can implement two-way communication to transfer information.

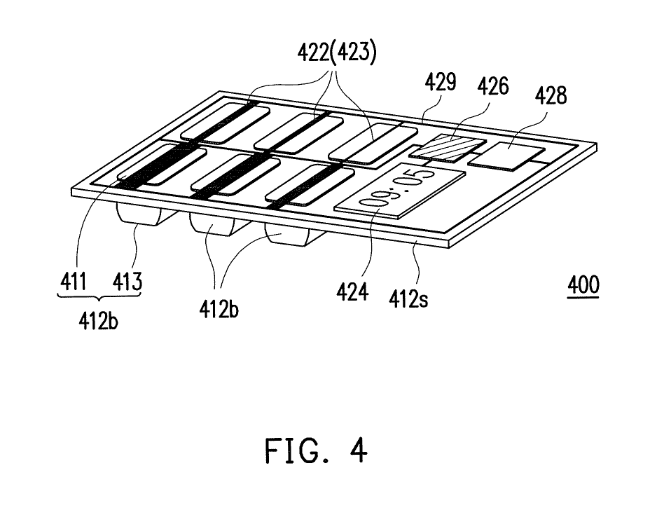

FIG. 4 is a schematic diagram of a smart medication device according to another embodiment of the invention. Referring to FIG. 4, in the present embodiment, the smart medication device 400 is similar to the smart medication device 200 of the embodiment of FIG. 2A, and a main difference therebetween is that the triggering structures 422 of the smart medication device 400 of the present embodiment are disposed on the opening portions 411 of the containing grooves 412b, and the triggering structures 422, for example, include conductive material elements 423.

In the present embodiment, the triggering structures 422 are, for example, disposed on the opening portions 411 of the containing grooves 412b. Therefore, when the medicine is taken out, the corresponding containing groove 412b is deformed due to the external force, and now the triggering structure 422 is also deformed by receiving the external force, for example, the triggering structure 422 is broken as the medicine is taken out, so as to produce the triggering signal S. In the present embodiment, the conductive material elements 423, for example, respectively have a different length, width or area, and transmit the triggering signal S to the controller 426 through different signal transmission paths (the conducting wire 429). In the present embodiment the conductive material elements 423 are, for example, coupled to the controller 426 through a serial or parallel manner, though the invention is not limited thereto. In an embodiment, the controller 426, for example, detects whether the signal transmission path coupled to the conductive material element 423 is in an open circuit state. When the conductive material element 423 is broken, it represents that the signal transmission path thereof is in the open circuit state. Regarding the conductive material elements 423 with different structure characteristics, the triggering signals S generated due to the open circuits caused by broken of the conductive material elements 423 may have different current values or voltage values. Therefore, the controller 426 can accordingly record the medicine administration information of the user. In the present embodiment, a material of the conductive material element 423 may include silver, carbon, conductive ink or copper. Moreover, in the present embodiment, the triggering structures 422 used for generating the triggering signals S is not limited to be the conductive material elements 423, but can also be piezoelectric material elements, which is not limited by the invention.

It should be noted that in the present embodiment, the conductive material elements 423 are first connected in series and are then coupled to the controller in a parallel manner, by which the number of pins of the controller 426 required for coupling to the conductive material elements 423 is decreased, so as to decrease manufacturing cost of the controller 426.

Moreover, since those skilled in the art can learn enough instructions and recommendations of the method for displaying the medicine administration information by the smart medication device of the present embodiment from the descriptions of the embodiments of FIG. 1A to FIG. 3B, detailed description thereof is not repeated

In summary, in the embodiment of the invention, through corresponding configuration of the containing structures and the triggering structures in the smart medication device, the triggering structure is deformed by receiving the external force, and generates the triggering signal according to a corresponding structure characteristic thereof. The e-paper display apparatus displays an image according to the triggering signal to remind the user to take medicine, so as to effectively decrease a waste of medical resources.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A smart medication device, comprising:
a non-electrical component, comprising a containing structure configured to contain one to a plurality of medicines; and
an electrical component, disposed on the non-electrical component, and comprising a triggering structure and an e-paper display apparatus, wherein the triggering structure is configured to generate a triggering signal to trigger the e-paper display apparatus to display medicine administration information,
wherein the triggering structure is deformed by receiving an external force to generate the triggering signal, the triggering signal has an electrical characteristic, and the electrical characteristic is determined by a structure characteristic of the triggering structure.

2. The smart medication device as claimed in claim 1, wherein the containing structure comprises a carrying substrate and a plurality of containing grooves, the carrying substrate is configured to carry the electrical component, and the containing grooves are disposed on the carrying substrate, and are respectively configured to contain one to a plurality of medicines.

3. The smart medication device as claimed in claim 2, wherein the non-electrical component further comprises a box housing, and the containing structure is disposed in the box housing.

4. The smart medication device as claimed in claim 3, wherein the e-paper display apparatus is disposed on one of the carrying substrate and the box housing.

5. The smart medication device as claimed in claim 3, wherein the triggering structure is disposed on the box housing, and when the box housing is changed from a first use state to a second use state, the triggering structure is deformed by receiving the external force to generate the triggering signal.

6. The smart medication device as claimed in claim 2, wherein the triggering structure is disposed on the containing grooves, and when each of the containing grooves is deformed by receiving the external force, the triggering structure is deformed by receiving the external force to generate the triggering signal.

7. The smart medication device as claimed in claim 6, wherein each of the containing grooves comprises a top portion and an opening portion, and the triggering structure is disposed on one of the top portion and the opening portion.

8. The smart medication device as claimed in claim 1, wherein the electrical component further comprises:
a controller, disposed on the containing structure, and configured to receive the triggering signal, so as to control the e-paper display apparatus to display the medicine administration information; and
a power storage device, electrically connected to the controller, and configured to provide power required by the controller.

9. The smart medication device as claimed in claim 1, wherein the triggering structure comprises a piezoelectric material element, and the structure characteristic of the triggering structure comprises at least one of a shape, a length, a width and an area of the piezoelectric material element.

10. The smart medication device as claimed in claim 1, wherein the triggering structure comprises a conductive material element, and the structure characteristic of the triggering structure comprises at least one of a shape, a length, a width and an area of the conductive material element.

11. The smart medication device as claimed in claim 1, wherein the electrical characteristic of the triggering signal comprises at least one of a current value and a voltage value of the triggering signal.
